(19) United States
(12) Patent Application Publication
(10) Pub. No.: US 2007/0125589 A1
(43) Pub. Date: Jun. 7, 2007

(54) Situationally dependent vehicle structure for pedestrian protection

(76) Inventor: Morgan D. Murphy, Kokomo, IN (US)

Correspondence Address: DELPHI TECHNOLOGIES, INC., M/C 480-410-202, PO BOX 5052, TROY, MI, 48007, US

(21) Appl. No.: 11/295,740

(22) Filed: Dec. 6, 2005

(51) Int. Cl. B60K 28/10

(52) U.S. Cl. 180/274

(57) ABSTRACT

A pedestrian safety system for a motor vehicle including a controller configured to cause selected modification of a situationally dependent structure in response to a detected vehicle condition.

### TECHNICAL BACKGROUND

The present invention relates generally to pedestrian safety systems for motor vehicles and, more particularly, to a situationally dependent vehicle structure which is configured to be modified in response to a detected vehicle condition.

### BACKGROUND OF THE INVENTION

When a moving vehicle strikes an obstacle, the obstacle often first hits the front bumper of the vehicle and then travels up over the bumper and lands on the hood. As such, the obstacle impacts both the bumper and the hood of the vehicle.

It is known in the art to provide impact sensing systems configured to detect an imminent impact and modify the bumper and/or hood of a vehicle to reduce the potential injury to a struck pedestrian. More particularly, the structure of the bumper may be modified in response to a detected imminent impact with an object. It is also known to raise the vehicle hood to provide a gap between the hood and the engine compartment thereby increasing the cushioning effect of the hood when imminent impact with an object is detected.

Bumpers have also been developed with additional cushion to reduce damaging impact with pedestrians. One problem with such a modified bumper design is that it tends to increase the repair costs resulting from low speed impacts. In general, a vehicle structure that is more pedestrian friendly often conflicts with other customer requirements, such as styling, high speed aerodynamics, and increase bumper durability.

### SUMMARY OF THE INVENTION

According to an illustrative embodiment of the present disclosure, a pedestrian safety system for a motor vehicle includes a bumper positioned in front of an engine compartment, and a hood positioned above the engine compartment. A bumper actuator is operably coupled to the bumper and is configured to modify the stiffness of the bumper. A hood actuator is operably coupled to the hood and is configured to vertically move the hood relative to the engine compartment. A vehicle condition sensor is configured to detect a vehicle condition. A controller is in communication with the bumper actuator, the hood actuator, and the sensor. The controller is configured to control the bumper actuator and the hood actuator in response to the detected vehicle condition.

According to a further illustrative embodiment of the present disclosure, a pedestrian safety system for a motor vehicle includes a hood covering an engine compartment, and an actuator operably coupled to the hood and configured to raise and lower the hood. A sensor is configured to detect a vehicle condition including at least one of vehicle speed and vehicle location. A controller is in communication with the sensor and is configured to cause the actuator to move the hood in response to the detected condition.

According to yet another illustrative embodiment of the present disclosure, a pedestrian safety system for a motor vehicle includes a situationally dependent structure, and a sensor configured to detect the location of the vehicle. A controller is in communication with the sensor and is configured to cause selected modification of the situationally dependent structure in response to the detected vehicle location.

According to a further illustrative embodiment of the present disclosure, a method of modifying a situationally dependent vehicle structure includes the steps of providing a situationally dependent vehicle structure, and detecting the location of the vehicle. The method further includes the steps of determining whether the detected location is within a high pedestrian contact zone, and modifying the situationally dependent vehicle structure if the detected location is within the high pedestrian contact zone.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of an illustrative embodiment pedestrian safety system of the present disclosure;

FIG. 2 is a partial perspective view of a vehicle including the pedestrian safety system of FIG. 1, with cutaways to show details thereof;

FIG. 3 is a partial top plan view, in partial schematic, of a bumper according to the pedestrian safety system of FIG. 1, illustrating the bumper in a rigid mode;

FIG. 4 is a top plan view similar to FIG. 3, illustrating the bumper in a spring mode;

FIG. 5 is a partial side elevation view illustrating the front of the vehicle incorporating the pedestrian safety system of FIG. 1;

FIG. 6 is a flow chart illustrating a method of operation of the pedestrian safety system of FIG. 1; and

FIG. 7 is a partial schematic view illustrating the vehicle incorporating the pedestrian safety system of FIG. 1 travelling through a high pedestrian contact zone.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DETAILED DESCRIPTION OF INVENTION

The embodiments discussed below are not intended to be exhaustive or limit the invention to the precise forms disclosed in the following detailed description. Rather, the embodiments are chosen and described so that others skilled in the art may utilize their teachings.

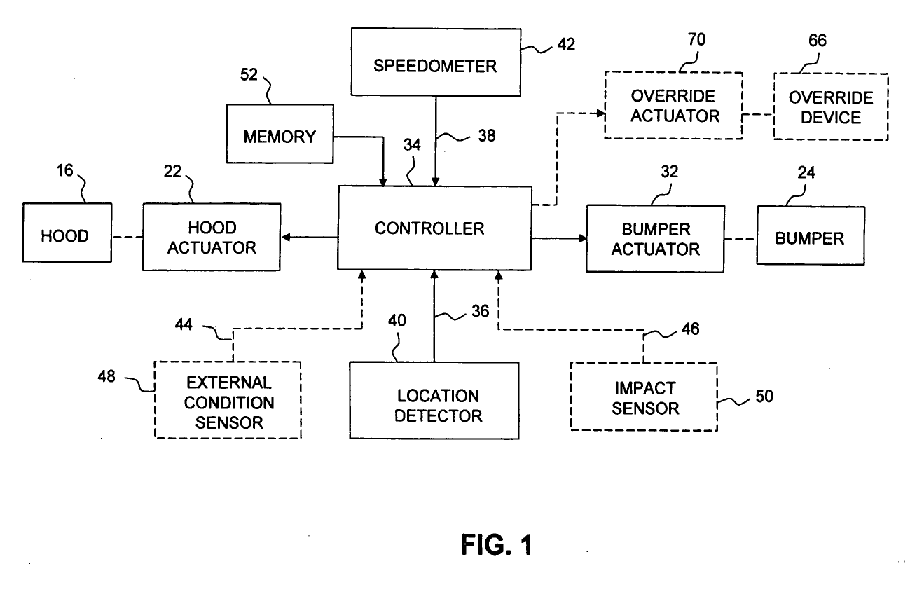

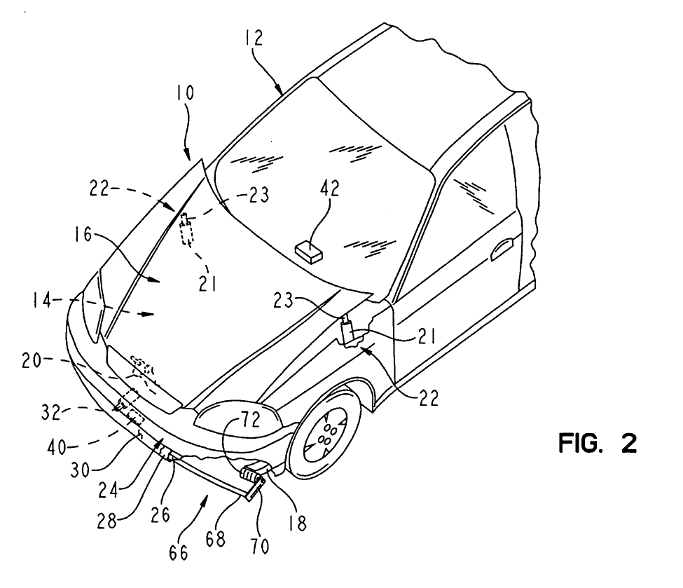

Referring initially to FIGS. 1 and 2, a pedestrian safety system 10 is shown for use within a motor vehicle 12. The vehicle 12 is of conventional design and includes an engine compartment 14 covered by a hood 16. The hood 16 may be supported for pivoting movement in the manner known in the art. A front part of the hood 16 may be secured relative to the body frame 18 through a conventional latch 20. Right and left hood actuators 22 are operably coupled to the hood 16 and are configured to raise and lower the hood relative to the engine compartment 14 between deployed and rest modes. The actuators 22 may be of conventional design, and each illustratively comprises an electric motor 21 configured to move a drive element 23.

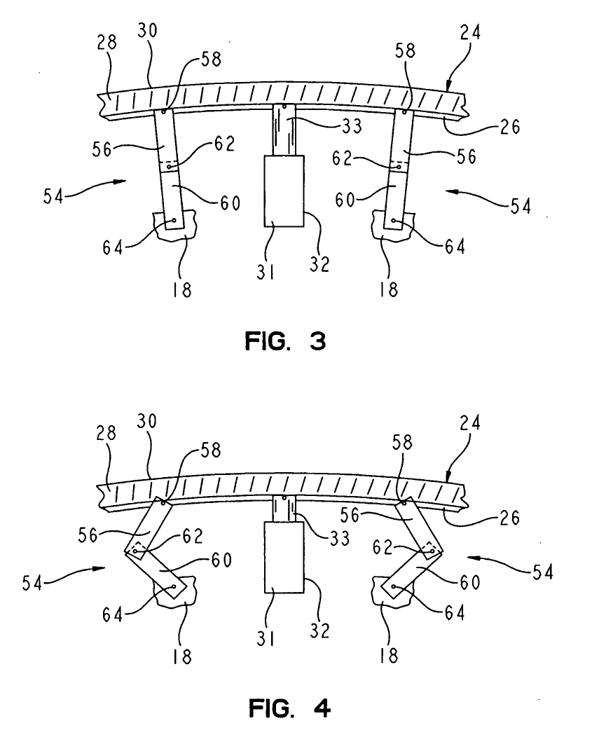

With reference to FIGS. 2 and 3, the vehicle 12 also includes a front bumper 24 illustratively having a support beam 26 which is coupled to an energy absorbent foam material 28. The exterior face of the bumper 24 is illustratively covered by a facia 30. A bumper actuator 32 is operably coupled to the bumper 24 and is configured to move the bumper 24 forwardly and rearwardly between deployed and rest modes. The actuator 32 may be of conventional design and illustratively comprises an electric motor 31 configured to move a drive element 33.

With further reference to FIG. 1, the pedestrian safety system 10 includes a controller 34, illustratively a microprocessor, which is configured to make a deployment decision regarding the situationally dependent vehicle structure (for example, the hood 16 or the bumper 24) based upon a detected vehicle condition. More particularly, the controller 34 is configured to receive input signals 36 and 38 from vehicle condition sensors, illustratively a location detector 40 and a speedometer 42, respectively. The location detector 40 is configured to provide a signal 36 indicative of the vehicle location, while the speedometer 42 is configured to provide a signal 38 indicative of the vehicle speed. Illustratively, the location detector 40 may comprise a global positioning system (GPS) sensor, while the speedometer may comprise a conventional vehicle speed detector. Input signals 44 and 46 may also be provided by additional vehicle condition sensors, such as an external condition sensor 48 and an impact sensor 50, respectively.

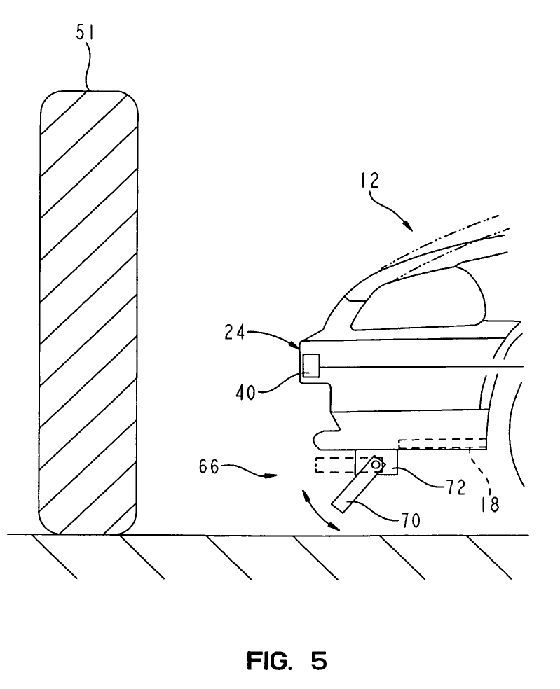

The external condition sensor 48 may be used to detect objects 51 (FIG. 5) within the vehicle's path. The external condition sensor 48 may comprise a camera, infrared sensor, radar or other similar device. Input from the external condition sensor 48 may be used to supplement the configuration deployment decision made by the controller 34. For example, the distance to a leading vehicle in front of the sensor 48 in combination with the vehicle speed may be used by the controller 34 to determine an appropriate deployment of the hood 16 and/or the bumper 24. Moreover, distance to the next vehicle and vehicle speed may be used to eliminate deployment in situations where a pedestrian is unlikely to enter the space between the vehicles. The impact sensor 50 may comprise an acceleration sensor which is configured to detect an imminent collision and to provide a corresponding signal to the controller.

The controller 34 is configured to control operation of the hood actuators 22 and the bumper actuator 32 in response to the detected vehicle conditions of location and speed, as indicated by the input signals 36 and 38. In one illustrative embodiment, the location detector 40 provides input of vehicle location to the controller 34 which, in turn, determines the likelihood of pedestrian contact. For example, the controller 34 will determine whether the vehicle location is in a high pedestrian contact zone. Such a high pedestrian contact zone may be stored within a memory 52 and supplied to the controller 34. Illustratively, such a high pedestrian contact zone may be a neighbourhood where there is increased pedestrian traffic. In contrast, a remote highway would be given a lower likelihood of contact and not classified as a high pedestrian contact zone. Based upon the level of pedestrian contact anticipated, the controller 34 will make a decision as to whether to deploy, or enable a structural modification of, the hood 16 or bumper 24.

In a further illustrative embodiment, vehicle speed may also be considered in the deployment decision. At low speeds, illustratively less than eight miles per hour, and at high speeds, illustratively greater than twenty-five miles per hour, no changes in structure would be required by the controller 34. Average speed over a relatively short period of time is used by the controller 34 in its decision making process. In some areas, for example large areas within cities, the system 10 could be locked into a pedestrian friendly configuration. In other words, the controller 34 would maintain the structures 16 and 24 in rest modes.

By activating the hood actuators 22, the vehicle hood 16 is raised, illustratively by approximately two inches. This implementation allows for styling requirements which are primary concerns at low speeds, and for aerodynamic requirements which are primary concerns at higher speeds. At intermediate speeds, the hood 22 is elevated above the engine compartment 14 to provide additional cushioning effect for the pedestrian. In the illustrative embodiment, the controller actuates the actuators 22 to raise the hood 16 only when the detected speed is between 8 and 25 miles per hour. It may be appreciated that this speed range may vary depending upon structural details and environmental conditions.

In order to minimize pedestrian leg injuries, several options are available to stiffen or soften the contact surface of the bumper 24. Utilizing magnetically or mechanically activated bi-stable devices, the structure of the bumper 24 can be made more rigid. As shown in FIGS. 3 and 4, in an illustrative embodiment, the bumper 24 is operably coupled to a pair of linkages 54. Each linkage 54 includes a first arm 56 operably coupled to the vehicle frame 18 through a first pivot 58, and a second arm 60 operably coupled to the first arm 56 and to the beam 26 through second and third pivots 62 and 64, respectively. During a rigid mode of operation as shown in FIG. 3, the bumper 24 has a column configuration which is significantly stiffer because load is transferred through the column structure instead of through the foam material 28. Such a column configuration will reduce vehicle damage at lower speeds. In a spring mode of operation as shown in FIG. 4, the load is more readily transferred through the foam material 28 to create a softer contact surface that better reduces pedestrian leg injuries. Operation of the bumper actuator 32 moves the bumper 24 between the rigid and spring modes of operation. Other means to change the rigidity of the bumper 24 may include air pressure or other fluid systems. In addition to bumper rigidity, for some vehicles it would be beneficial to extend the bumper 24 two to three inches to reduce pedestrian leg injuries.

As shown in FIG. 5, for certain vehicles an override device 66 may be deployed. The override device 66 illustratively includes a lateral member 68 which is deployable from a raised position to a lowered position. A pair of legs 70 are pivotally supported and configured to be moved by an override actuator 72, illustratively an electric motor. In the lowered position, the override device 66 forms a barrier to prevent a pedestrian from being driven over by the vehicle 12.

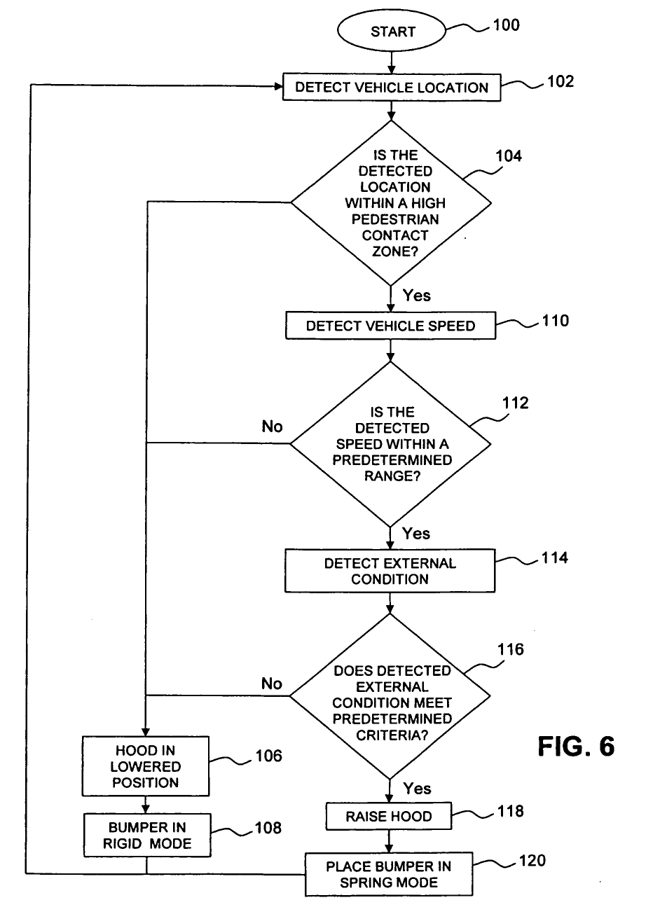

With reference now to FIG. 6, illustrative operation of the pedestrian safety system 10 begins at block 100. At block 102 the location detector 40 detects the vehicle location. At block 104, controller 34 determines whether the detected location is within a high pedestrian contact zone. If not, then the hood 16 remains in its lowered or rest position, as indicated by block 106, and the bumper 24 is in its rigid or rest mode, as indicated by block 108. Returning to block 104, if the detected location is within a high pedestrian contact zone, then the vehicle speed is detected at block 110. At block 112, the controller 34 determines whether the detected speed is within a predetermined range. Illustratively, the predetermined range is between eight and twenty-five miles per hour. If the detected speed is not within the predetermined range, then the process continues to block 106 where the hood 16 is in its lowered position and to block 108 where the bumper 24 is in its rigid mode. If the detected speed is within the predetermined range, then the process continues to optional block 114 where external conditions are detected.

At optional block 116, the controller 34 determines whether the external conditions meet predetermined criteria. For example, the external condition may be the distance to object 51 in front of the vehicle 12. Illustratively, based upon the detected speed and the distance to a leading vehicle, the controller 34 may determine that it is unlikely the pedestrian would get between the vehicles. As such, if the predetermined criteria is not met (for example, the distance is less than a predetermined amount), then the process continues to block 106 where the hood 16 is in its lowered position, and to block 108 where the bumper 24 is in its rigid mode. If the predetermined condition is met, then the process continues to block 118, where the hood 16 is raised or deployed, and to block 120 where the bumper 24 is deployed to its spring mode of operation. The process then returns to block 102 where the vehicle location is detected and the steps continue in the manner identified above.

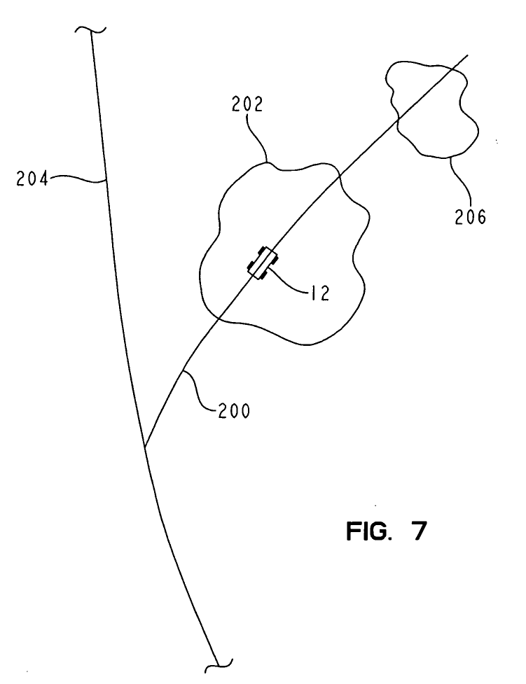

FIG. 7 shows a vehicle 12 travelling along a road 200 through a first high pedestrian contact zone 202. If the vehicle 12 is travelling along road 204, the controller 34 identifies this as a low pedestrian contact zone. As such, the controller 34 would not cause the hood 16 or the bumper 24 to deploy. As the car travels along road 200 and enters the first high pedestrian zone 202, the controller 34 causes the bumper 24 and the hood 16 to deploy if the vehicle speed is within the predetermined range. As the vehicle 12 travels out of the first high pedestrian contact zone 202 on its way to a second high pedestrian contact zone 206, the controller 34 causes the actuators 22 and 32 to deactivate and return the hood 16 and bumper 24 to their rest modes. Once the vehicle 12 enters the second high pedestrian contact zone 206, the controller 34 again causes the bumper 24 and the hood 16 to deploy if the vehicle speed is within the predetermined range.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A pedestrian safety system for a motor vehicle, the system comprising:
a bumper positioned in front of an engine compartment;
a hood positioned above the engine compartment;
a bumper actuator operably coupled to the bumper, the bumper actuator being configured to modify the stiffness of the bumper;
a hood actuator operably coupled to the hood, the hood actuator being configured to vertically move the hood relative to the engine compartment; and
a vehicle condition sensor configured to detect a vehicle condition;
a controller in communication with the bumper actuator, the hood actuator, and the sensor, the controller being configured to control the bumper actuator and the hood actuator in response to the detected vehicle condition.

2. The pedestrian safety system of claim 1, wherein the sensor comprises a speedometer to detect the speed of the vehicle.

3. The pedestrian safety system of claim 1, wherein the sensor comprises a vehicle location detector to detect the location of the vehicle.

4. The pedestrian safety system of claim 3, wherein the vehicle location detector comprises a global positioning system detector.

5. The pedestrian safety system of claim 3, wherein the controller is configured to determine if the vehicle is in a high pedestrian contact zone, to control the bumper actuator to soften the bumper if the vehicle is in the high pedestrian contact zone, and to control the hood actuator to raise the hood if the vehicle is in the high pedestrian contact zone.

6. The pedestrian safety system of claim 1, wherein the bumper includes a support beam and a linkage pivotably coupled to the support beam, the support beam being configured to operate in a rigid mode to stiffen the bumper and to operate in a spring mode to soften the bumper in response to the position of the bumper actuator.

7. The pedestrian safety system of claim 1, further comprising an external condition sensor configured to detect the position of the vehicle relative to an external object.

8. The pedestrian safety system of claim 1, further comprising an override device supported by the bumper, wherein the controller is configured to cause the override device to move vertically in response to the detected vehicle condition.

9. A pedestrian safety system for a motor vehicle, the pedestrian safety system comprising:
a hood covering an engine compartment;
an actuator operably coupled to the hood and configured to raise and lower the hood;
a sensor configured to detect a vehicle condition, the vehicle condition including at least one of vehicle speed and vehicle location; and
a controller in communication with the sensor and configured to cause the actuator to move the hood in response to the detected condition.

10. The pedestrian safety system of claim 9, wherein the sensor comprises a speedometer configured to detect the vehicle speed.

11. The pedestrian safety system of claim 9, wherein the sensor comprises a vehicle location detector configured to detect the vehicle location.

12. The pedestrian safety system of claim 11, wherein the vehicle location detector comprises a global positioning system detector.

13. The pedestrian safety system of claim 9, wherein the controller is configured to determine if the vehicle is in a high pedestrian contact zone, and to control the actuator to raise the hood if the vehicle is in the high pedestrian contact zone.

14. The pedestrian safety system of claim 9, further comprising a bumper and a bumper actuator operably coupled to the bumper, the bumper actuator being configured to modify the stiffness of the bumper in response to the detected condition.

15. A pedestrian safety system for a motor vehicle, the pedestrian safety system comprising:
a situationally dependent structure;
a sensor configured to detect the location of the vehicle; and
a controller in communication with the sensor and configured to cause selective modification of the situationally dependent structure in response to the detected vehicle location.

16. The pedestrian safety system of claim 15, wherein the situationally dependent structure includes at least one of a hood and a bumper.

17. The pedestrian safety system of claim 16, wherein the bumper includes a support beam and a linkage pivotably coupled to the support beam, the support beam being configured to operate in a rigid mode to stiffen the bumper and to operate in a spring mode to soften the bumper.

18. The pedestrian safety system of claim 15, wherein the sensor comprises a global positioning system detector.

19. The pedestrian safety system of claim 15, wherein the controller is configured to determine if the vehicle is in a high pedestrian contact zone, and to modify the situationally dependent structure if the vehicle is in the high pedestrian contact zone.

20. The pedestrian safety system of claim 15, further comprising an actuator operably coupled to the situationally dependent structure and configured to be controlled by the controller.

21. The pedestrian safety system of claim 15, further comprising an external condition sensor configured to detect the position of the vehicle relative to an external object.

22. The pedestrian safety system of claim 15, further comprising an override device, wherein the controller is configured to cause the override device to vertically move in response to the detected vehicle location.

23. The pedestrian safety system of claim 15, further comprising a speedometer in communication with the controller and configured to detect the speed of the vehicle, the controller being configured to cause selective modification of the situationally dependent structure in response to the detected vehicle speed.

24. A method of modifying a situationally dependent vehicle structure, the method comprising the steps of:
providing a situationally dependent vehicle structure;
detecting the location of the vehicle;
determining whether the detected location is within a high pedestrian contact zone; and
modifying the situationally dependent vehicle structure if the detected location is within the high pedestrian contact zone.

25. The method of claim 24, wherein the situationally dependent vehicle structure comprises at least one of a hood and a bumper.

26. The method of claim 24, wherein the modifying step comprises providing an actuator and controlling the actuator in response to the detected location.

27. The method of claim 24, further comprising the steps of detecting the speed of the vehicle and modifying the situationally dependent vehicle structure if the speed is within a predetermined range.
